(19) United States
(12) Patent Application Publication
(10) Pub. No.: US 2008/0273739 A1
(43) Pub. Date: Nov. 6, 2008

(54) Ribbon transducer with improved excursion and dispersion characteristics

(75) Inventor: George E. Short, Old Forge, NY (US)

Correspondence Address: GEORGE E SHORT III, P.O. BOX 534, OLD FORGE, NY, 13420, US

(73) Assignee: George E. Short III, Old Forge, NY (US)

(21) Appl. No.: 11/799,246

(22) Filed: May 1, 2007

(51) Int. Cl. H04R 9/04

(52) U.S. Cl. 381/399

(57) ABSTRACT

“Ribbon tranducer with improved excursion and dispersion characteristics”

A method of employing one or more flexible suspension elements attached to a ribbon-type electroacoustic transducer diaphragm such that a bend created in the diaphragm by the flexible suspension element(s) allows the transducer to display broader acoustic dispersion in the plane orthagonal to the net diaphragm surface is described. Additionally, a type of material employed for the flexible suspension which offers minimal acoustic interference to sound radiated from the diaphragm.

### BACKGROUND OF THE INVENTION

The invention was conceived of, designed and constructed as an electroacoustic transducer which displays improvement in excursion and dispersion over existing designs.

This type of transducer is usually referred to as a “ribbon” transducer and is generally used for audio reproduction applications as a high frequency, mid-frequency or full range unit.

Conventional ribbon transducer designs employ a diaphragm made of conductive material or film adhered to conductive material suspended between two parallel rows of magnets which create a magnetic field. The diaphragm may or may not be corrugated. Interaction of alternating current flow though the conductive material and the magnetic field causes the conductive material and the diaphragm to vibrate. (FIG. 1 and FIG. 2).

Conventional ribbon transducer designs have excursion limitations caused by small variations in the magnetic field and small variations in tension along the diaphragm length. Under high excursion, conventional ribbon transducers invariably twist or flutter, causing audible and measurable distortion.

Conventional ribbon transducer designs have a “preferred listening axis” which is an axis orthagonal to the diaphragm surface and roughly bisects the diaphragm along its longest dimension. Above and below this “listening” axis, the measured and perceived frequency response of the transducer is unsatisfactory when compared with the measured and perceived frequency response of the transducer on this “listening” axis (FIG. 2).

Some past designs have attempted to overcome the limitation of a single “preferred listening axis” by adding a fixed support or series of fixed supports rigidly attached to the diaphragm which creates a permanent bend or series of bends in the diaphragm, thereby creating a series of shorter diaphragms, each with its own “preferred listening axis” (FIG. 3). The drawback of this approach is that the maximum amount of air volume that can be displaced by the motion of the diaphragm (that is, the product of the diaphragm's net surface area and the diaphragms maximum motion perpendicular to its surface area) is reduced because of the additional rigid attachment to the support(s). Because the low frequency performance limit of the transducer is proportional to the amount of air volume the diaphragm can displace, the low frequency performance is compromised by employing this rigid support approach.

Other past designs have used a series of shorter individual ribbon transducers, at least one of which is mounted at a different angle than the others, to create a secondary and additional “preferred listening axes”. As with the rigid support approach described above, the multiple short ribbon approach described here also has compromised low frequency performance.

### BRIEF SUMMARY OF THE INVENTION

In this invention, the ribbon diaphragm is attached to a compliant suspension element at some point along its length. The compliance of the suspension element allows for some motion of the diaphragm at the point of attachment (FIG. 4).

An aspect of this invention is that the suspension material employed may be made of a loosely woven material (such as a section of flexible screen) such that the suspension material has minimum interference with the sound waves radiated by the diaphragm.

Another aspect of this invention is that the compliance (or “spring force”) of the suspension element in the direction orthagonal to the plane of the diaphragm at rest can be made to create a bend in the diaphragm, thereby creating an additional “preferred listening axis”. (FIG. 5).

Another aspect of this invention is that torsional stiffness of the suspension element may also assist in centering the diaphragm in the magnetic gap and preventing it from twisting or fluttering during its motion. (FIG. 7).

A variation of this suspension method is a transducer constructed with several such compliant suspension elements which may have those qualities of the single suspension element described above, and which may be employed to create additional “preferred listening axes” (FIG. 8, FIG. 9, FIG. 10, FIG. 11 and FIG. 12).

### BRIEF DESCRIPTION OF THE DRAWINGS

FIG. 1) Front view of a conventional ribbon transducer

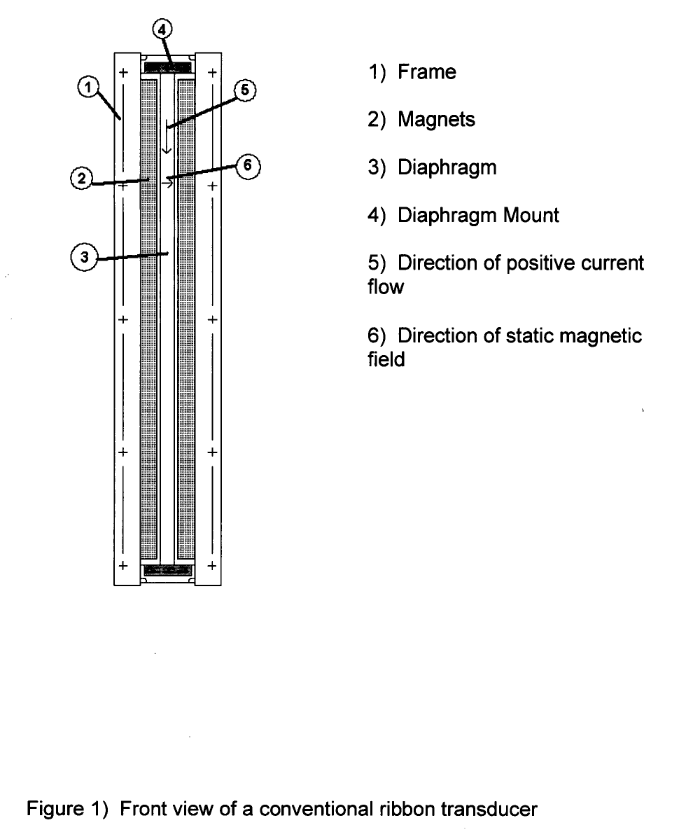

FIG. 2) Side cross-section view of a conventional ribbon transducer

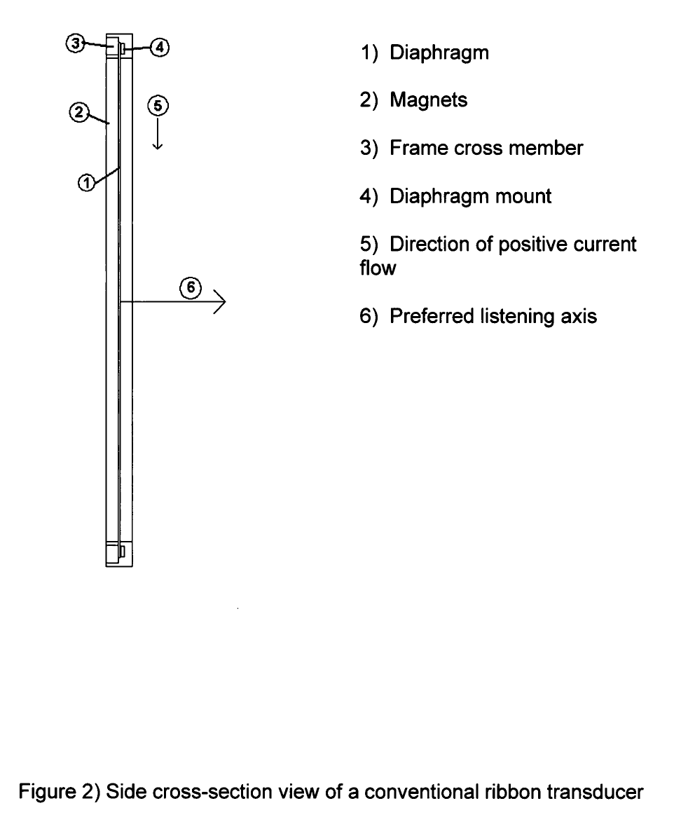

FIG. 3) Side cross-section view of a conventional ribbon transducer with fixed support and additional “preferred listening axis”.

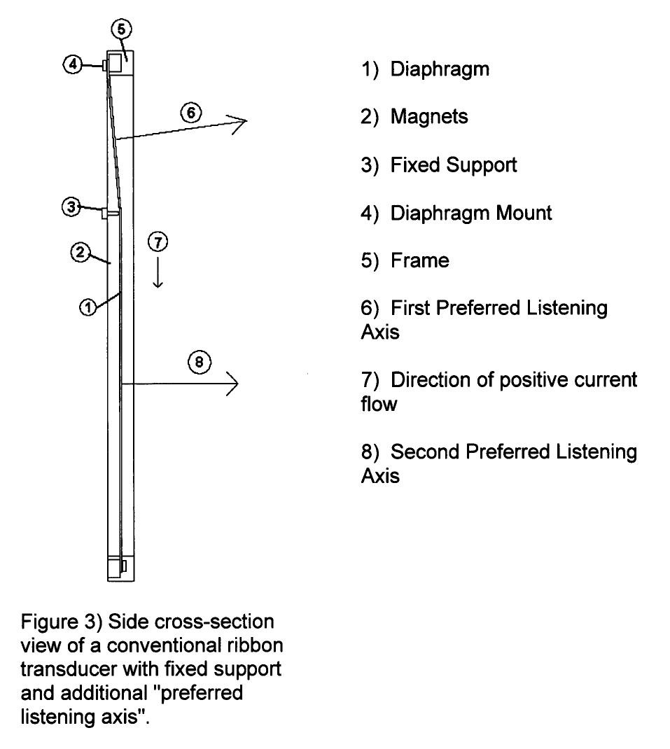

FIG. 4) Side view of the invention showing compliant suspension.

FIG. 5) Side view of the invention showing compliant suspension and additional “preferred listening axis”

FIG. 6) Rear view of the invention showing compliant suspension element

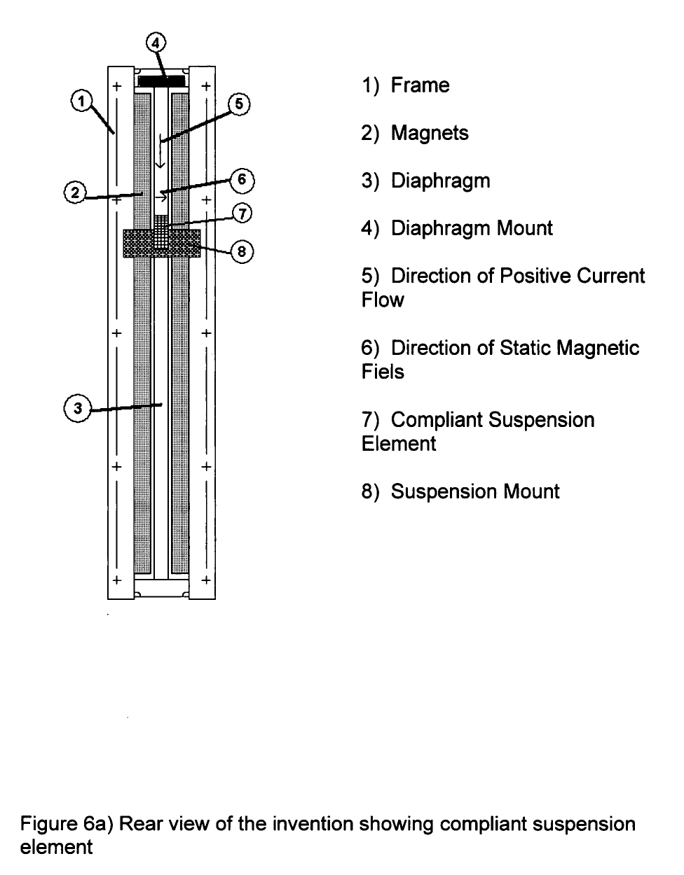

FIG. 7) Top cross section view of the invention showing compliant suspension element

FIG. 8) Side view of the invention showing more than one compliant suspension element and a single preferred listening axis.

FIG. 9) Side view of the invention showing additional compliant suspension elements and multiple preferred listening axes.

FIG. 10) Side view of the invention showing additional compliant suspension elements and multiple preferred listening axes.

FIG. 11) Side view of the invention showing additional compliant suspension elements and multiple preferred listening axes.

FIG. 12) Side view of the invention showing additional compliant suspension elements and multiple preferred listening axes.

### DETAILED DESCRIPTION OF THE INVENTION

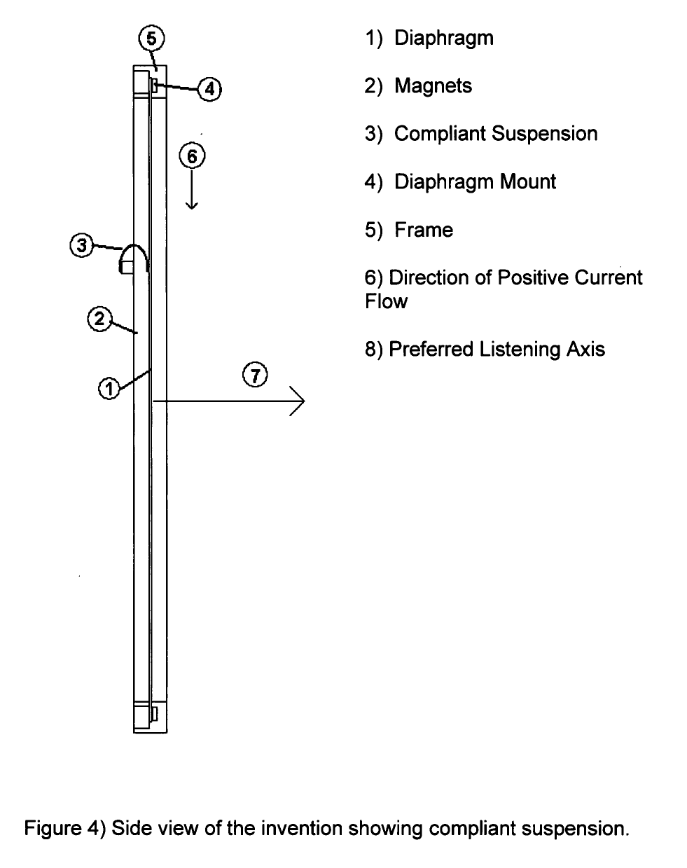

In this invention, the ribbon diaphragm is attached to a compliant suspension element at some point along its length. The compliance of the suspension element allows for some motion of the diaphragm at the point of attachment (FIG. 4).

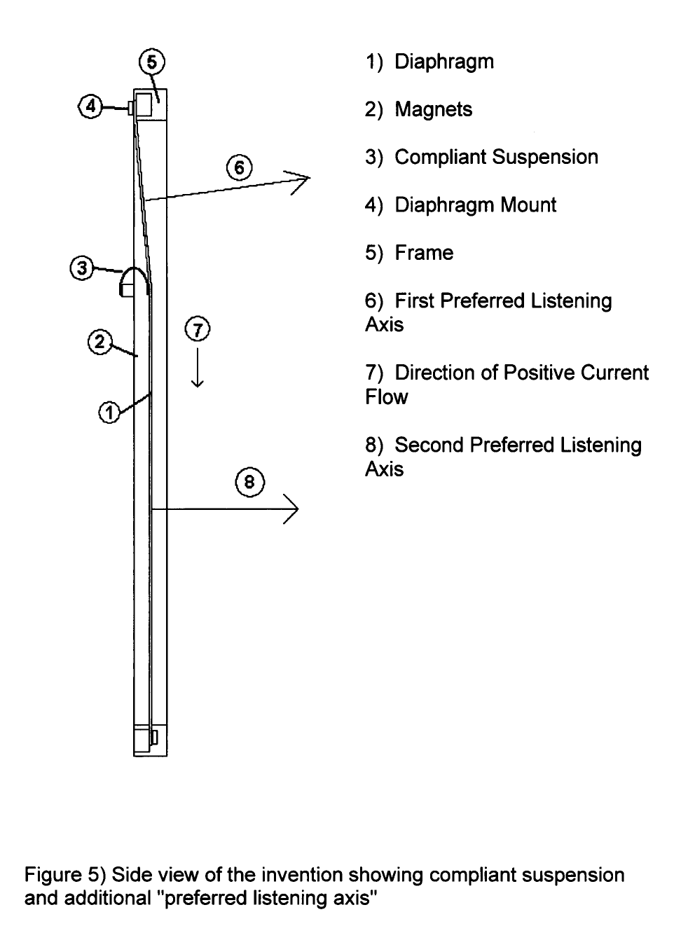

An aspect of this invention is that the suspension material employed may be made of a loosely woven material (such as a section of flexible screen) such that the suspension material has minimum interference with the sound waves radiated by the diaphragm. Another aspect of this invention is that the compliance (or “spring force”) of the suspension element in the direction orthagonal to the plane of the diaphragm at rest can be made to create a bend in the diaphragm, thereby creating an additional “preferred listening axis”. (FIG. 5).

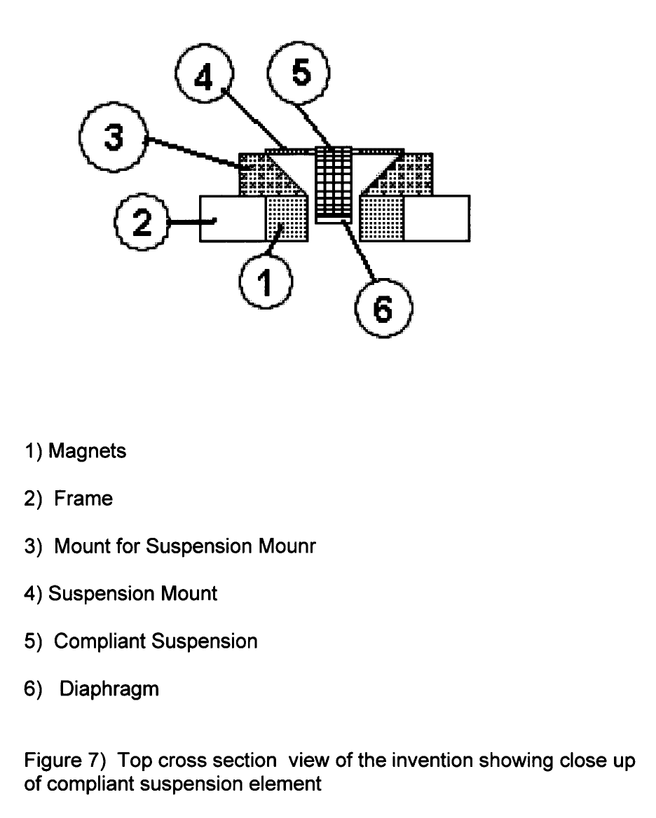

Another aspect of this invention is that torsional stiffness of the suspension element may also assist in centering the diaphragm in the magnetic gap and preventing it from twisting or fluttering during its motion. (FIG. 7).

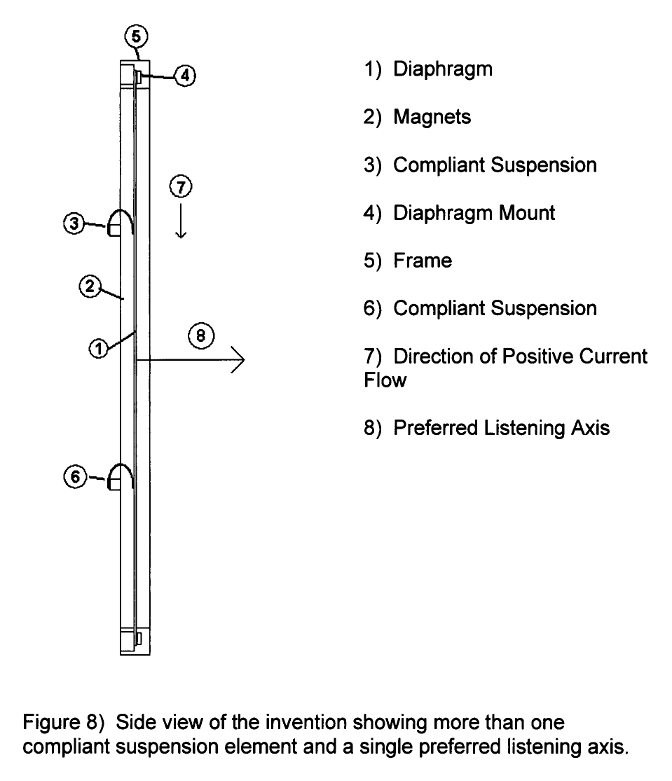

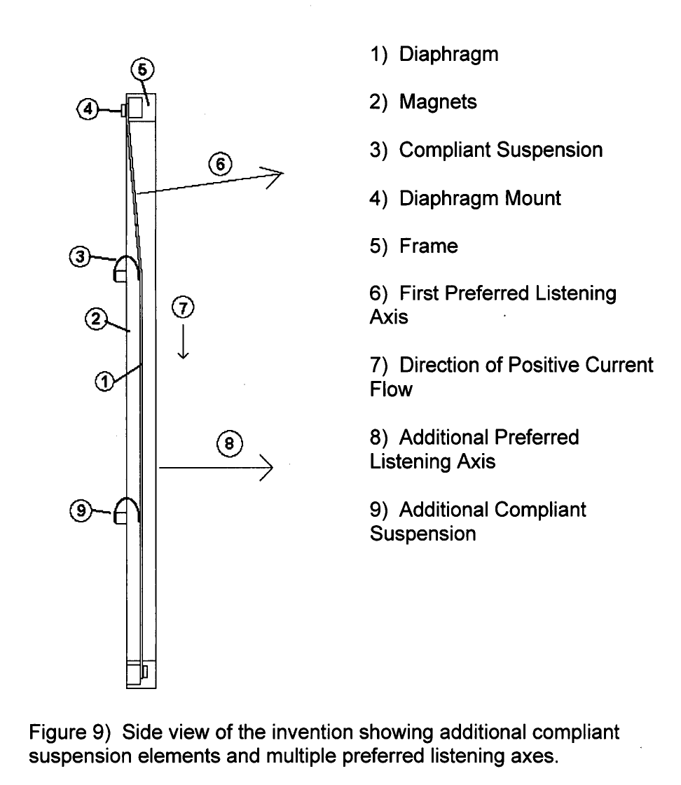

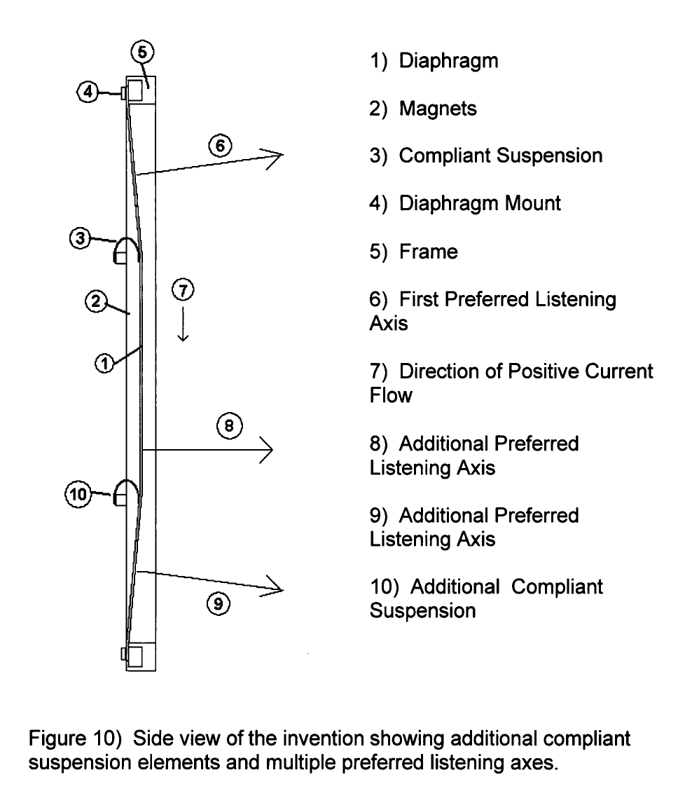

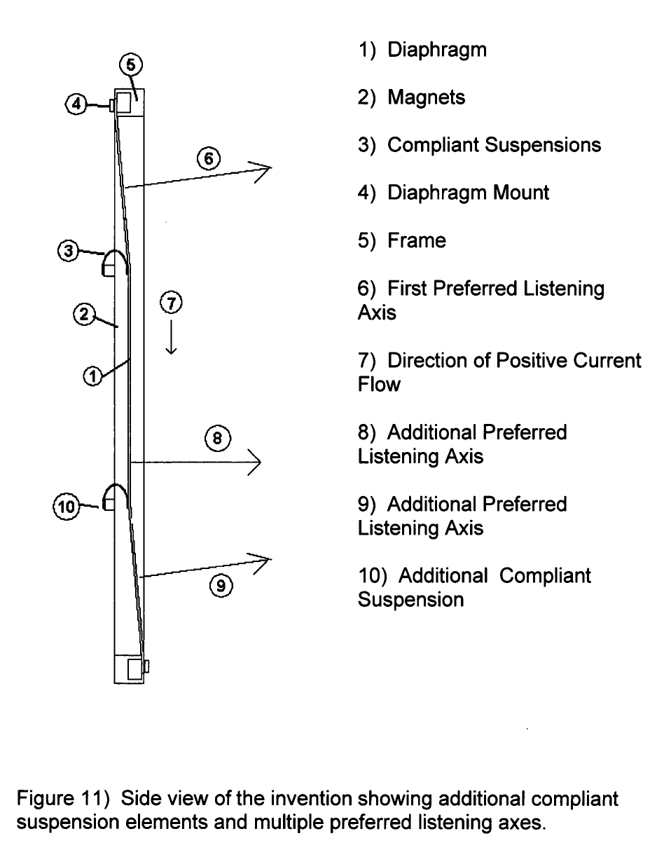

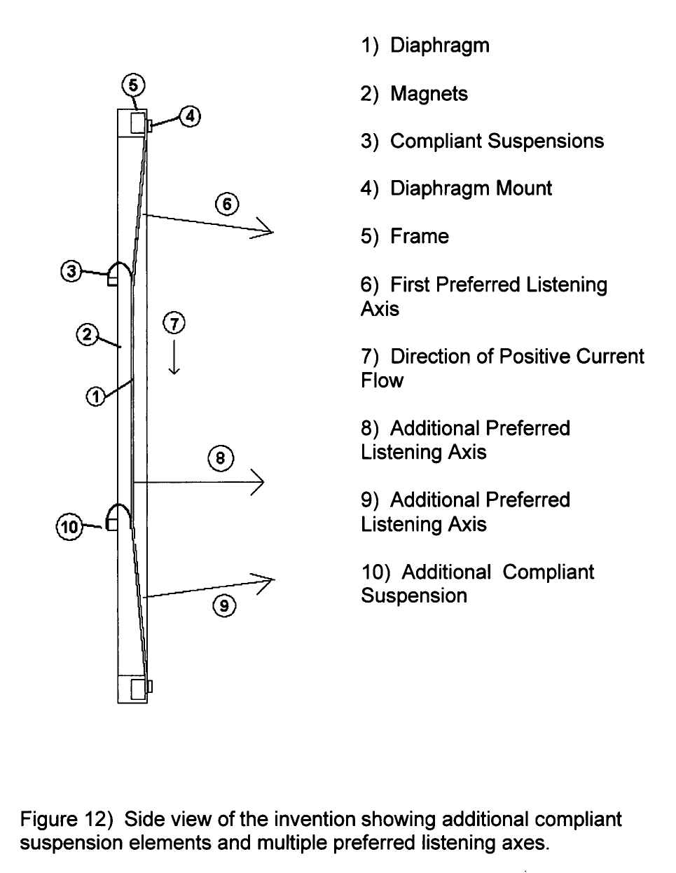

A variation of this suspension method is a transducer constructed with several such compliant suspension elements which may have those qualities of the single suspension element described above, and which may be employed to create additional “preferred listening axes” (FIG. 8, FIG. 9, FIG. 10, FIG. 11 and FIG. 12).

1) This invention employs the use of a loosely woven mesh as the suspension element, which provides minimal acoustic interference with the sound wave radiated by the diaphragm.

2) This invention allows the transducer element to have broader acoustic dispersion in the plane orthagonal to the net diaphragm surface. This invention is unique in that the improved dispersion pattern is achieved while compromises in the low frequency performance of the transducer are minimized.

3) This invention employs a suspension material which exhibits torsional stiffness in such a way that it centers the diaphragm in the magnetic gap and prevents the diaphragm from twisting out of the plane defined by the diaphragm's surface during diaphragm motion.
